(19) United States
(12) Patent Application Publication
(10) Pub. No.: US 2024/0321484 A1
(43) Pub. Date: Sep. 26, 2024

(54) UV-RESISTANT, COLOURED JACKETED CABLES

(71) Applicant: Northern Cables Inc., Brockville (CA)

(72) Inventors: Shelley BACON, Brockville (CA); Richard STEWART, Maitland (CA); Robert Gerard KELLY, Athens (CA)

(21) Appl. No.: 18/613,623

(22) Filed: Mar. 22, 2024

Related U.S. Application Data
(60) Provisional application No. 63/454,426, filed on Mar. 24, 2023.

(51) Int. Cl. H01B 7/18; C08K 3/04; C08K 3/22; C08L 23/06; H01B 3/44

(52) U.S. Cl. CPC H01B 7/187; C08K 3/04; C08K 3/22; C08L 23/06; H01B 3/441; C08K 2003/2241; C08K 2201/014; C08L 2203/202; C08L 2205/025; C08L 2207/062; C08L 2207/066; C08L 2312/00

(57) ABSTRACT

UV-resistant colored jacketed cables and a method of producing them are provided. The cables include an inner conductor, crosslinked insulation having carbon black dispersed therein surrounding the inner conductor, and an ultraviolet stable colored skin coat which optionally includes titanium dioxide. A method of making ultraviolet-resistant jacketed insulated conductors is also included in this disclosure.

### CROSS REFERENCE TO RELATED APPLICATIONS

This application claims priority to and the benefit of U.S. Provisional Patent Application No. 63/454,426 entitled “UV-RESISTANT, COLOURED JACKETED CABLES” filed on Mar. 24, 2023, the entire disclosure of which is incorporated by reference herein.

### FIELD

This invention pertains generally to cables for outdoor use and, more particularly UV-resistant, colored jacketed cables.

### BACKGROUND

Insulated conductors and jacketed cables are widely used outdoors or environs exposed to ultraviolet radiation including on roof tops, green houses and in solar arrays. Ultraviolet radiation is also used to disinfect spaces rapidly. Ultraviolet radiation causes the outer sheath or skin of the cable to become brittle and crack.

Prior art UV-resistant cables rely on the use of coatings or additives in the jacket or the skin that confer UV-resistance. U.S. Ser. No. 10/889,727B1 describes an electrical cable having a conductor having a protecting sheath and/or jacket comprising a base polymer a UV protecting agent mixed therein. Inclusion of UV blocking agents including carbon black or zinc oxide in the jacket impacts the color of the jacket. Examples of UV-resistant cables include SUNGEN®+SUNGEN E Photovoltaic Wire.

There exists a need in the market for insulated conductors that have long term UV resistance and colored jackets.

This background information is provided for the purpose of making known information believed by the applicant to be of possible relevance to the present invention. No admission is necessarily intended, nor should be construed, that any of the preceding information constitutes prior art against the present invention.

### SUMMARY

An object of the present invention is to provide UV-resistant, colored, jacketed cables.

In accordance with another aspect of the present invention, there is provided an ultraviolet-resistant jacketed insulated conductor comprising: (a) an inner conductor; (b) crosslinked insulation having carbon black dispersed therein surrounding the inner conductor; and (c) an ultraviolet stable colored skin coat.

In accordance with another aspect of the present invention, there is provided an ultraviolet-resistant jacketed insulated conductor comprising: (a) an inner conductor; (b) crosslinked polyethylene (XLPE) insulation having carbon black dispersed therein surrounding the inner conductor; and (c) an ultraviolet stable colored skin coat.

In accordance with another aspect of the invention there is provided a method of making ultraviolet-resistant jacketed insulated conducted comprising: advancing at least one conductor wire through an extrusion head; supplying a pre-mixed insulation composition to the extrusion head, wherein the pre-mixed insulation composition comprises: polymer base resins, cross-linking catalyst and carbon black; supplying a pre-mixed skin composition to a piggyback skin extruder, wherein the pre-mixed skin composition comprises polymer base resins, cross-linking catalyst colorant and UV protection agent and extruding the insulation composition from the extrusion head and around the conductor wire so as to form insulation surrounding the conductor wire and; extruding the skin composition from the piggyback skin extruder.

### BRIEF DESCRIPTION OF THE DRAWINGS

These and other features of the invention will become more apparent in the following detailed description in which reference is made to the appended drawings.

FIG. 1 is a photograph of cross section of #2 AWG compact aluminum 600V black/white skin sun resistance RW90 insulated conductor.

FIG. 2 is a cross section of an UV-resistant, coloured cables (1) detailing the compact aluminum conductor (10), UV-resistant insulation (20) and UV-resistant colored skin coat (30).

### DETAILED DESCRIPTION

The present invention provides ultraviolet-resistant jacketed insulated conductors, also called UV-resistant, coloured cables. In particular, the present invention provides coloured cables where the insulation is UV-blocking and the skin coat, i.e., jacket, is resistant to UV degradation thereby providing a colored, jacketed insulated conductor that maintains functional integrity following prolonged UV exposure even if jacket integrity is compromised.

By having both a UV resistant jacket and UV blocking insulation, the conductors of the invention have dual UV protection such that even if the jacket degrades or is damaged UV resistance is maintained.

UV resistance is integral to both the insulation and the skin coat thereby avoiding the use of UV resistant coatings. Optionally, functional coatings can be applied for some applications.

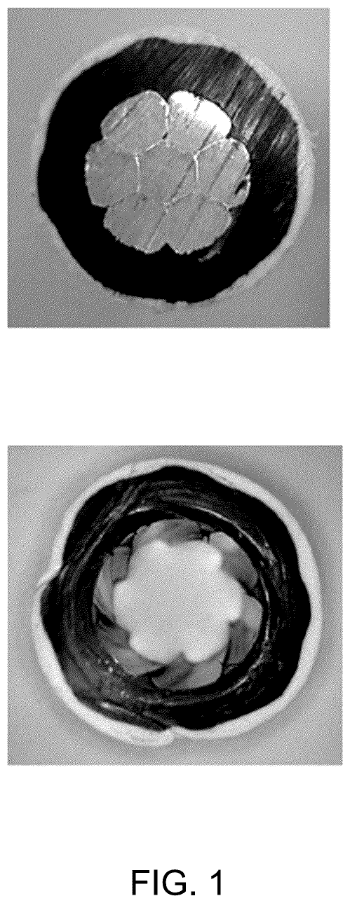

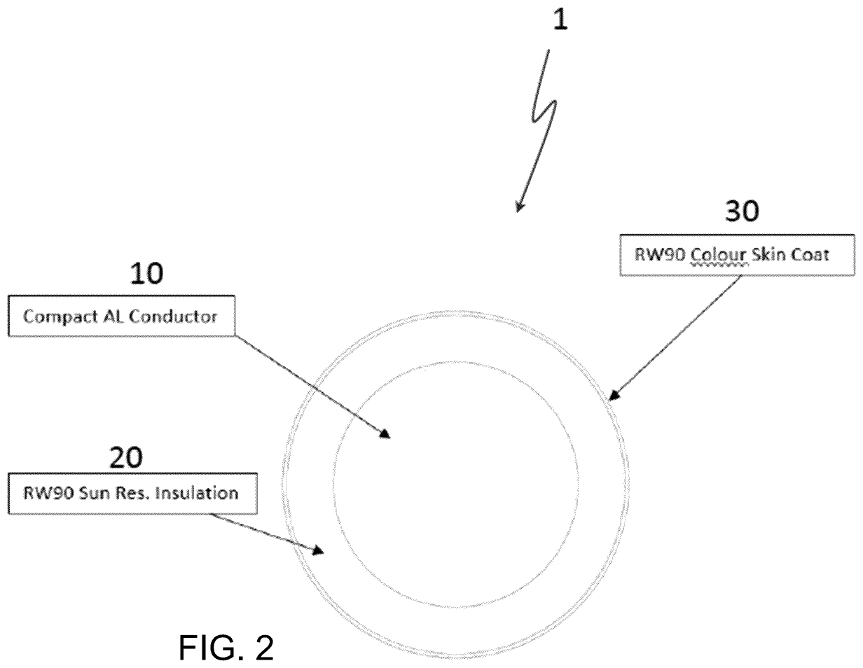

Referring to FIGS. 1 and 2, in some embodiments, the invention provides an ultraviolet-resistant jacketed, insulated conductor comprising an inner conductor; crosslinked polyethylene (XLPE) insulation having carbon black dispersed therein surrounding the inner conductor; and an ultraviolet stable colored skin coat.

The inner conductor can be of various gauges from #1 AWG to #14 AWG. In some embodiments, the conductor is a #2 AWG compact aluminum conductor having a nominal diameter of 0.286″.

The conductors include both stranded or solid conductors that are manufactured from different conducting materials including copper, aluminum, nickel or a combination thereof. The conductors can have a circular, oval, trapezoidal, square, rectangular, triangular, or other geometrical shape cross section.

The conductors of the UV-resistant, colored cables are insulated with appropriate cross-linked insulation material having carbon black dispersed therein. Appropriate insulation material is known in the art and includes Thermoplastic Heat and Water-resistant Nylon (THWN), Thermoplastic High Heat-resistant Nylon (THHN) or Thermoplastic Fixture Wire Nylon (TFN), Crosslinked Polyethylene High Heat Resistant and Water Resistant (XHHW-2) or cross-linked polyethylene (XLPE). It is known in the art that selection of appropriate insulation material is dependent on application, required temperature rating and conditions of use.

Carbon black is an UV protection agent and is provided in an amount of about 0.1% to about 15% by weight of the insulation. In some embodiments, the insulation is XLPE and includes about 2.5% carbon black by weight of insulation dispersed within the insulation. Appropriate carbon black is known in the art and includes the carbon black sold as DOW® 5410 Black Masterbatch.

In some embodiments, there is a minimum of 2.0% carbon black by weight of insulation measured to a depth of at least 0.76 mm (0.030 in) or to a depth of 50% of the minimum average thickness, optionally the carbon black particle size is 35 nm or less or shall be C or higher with an agglomerate size of 2 or less as measured in accordance with ASTM D2663, Test Method B-Agglomerate Method.

The insulation is formed from a polymeric composition which is formed by pre-mixing components thereof including the polymer base resins, cross-linking catalyst and carbon black. The pre-mixed composition is then extruded to form the insulation.

In some embodiments, the insulation formulation for extrusion comprises 55% Dow 5451 LLDPE, 33.5% Dow 5700 HDPE, 6.5% Dow 5410 Black Masterbatch and 5% Dow 5481 Catalyst.

Optionally, additional UV protective agents are also incorporated into the insulation. Appropriate additional UV protection agents include zinc oxide (ZnO) and titanium dioxide (TiO₂). Together with carbon black, the UV protection agents are provided in an amount of about 0.1% to about 15% by weight of the insulation.

The colored skin or jacket is formed from a polymeric composition formed by premixing components thereof including the polymer base resins, cross-linking catalyst, colorant and UV protection agent, optionally titanium dioxide. In some embodiments, titanium dioxide is provided in an amount of about 0.1% to about 15% by weight. In some embodiments, the titanium dioxide is provided in an amount of about 0.5% to about 1% by weight. In other embodiments, the titanium dioxide is provided in an about of about 0.6% to about 1.2% by weight.

In some embodiments, the colorant and UV protection agent are provided as a single additive such as UV Stable PolyOne® color chips or Avient® SMARTBATCH® UV stable Munsell color pellets. Optionally, the color pellets are provided in an amount of about 2% to about 4%. In some embodiments, the color pellets are provided in amount of about 3%.

The pre-mixed skin composition is then extruded using a piggyback extruder concurrently with the extrusion of the insulation composition.

In some embodiments, the insulation formulation for extrusion comprises 55% Dow 5451 LLDPE, 33.5% Dow 5700 HDPE, 6.5% Dow 5410 Black Masterbatch and 5% Dow 5481 Catalyst.

Optionally, the conductors are color coded based on application or standard codes. Appropriate colors may be dependent on application and include black, green, blue, red, white, brown, gray, orange yellow and may include a colored stripe.

The invention further provides a method of producing ultraviolet-resistant jacketed insulated conductors. The method generally comprises advancing at least one conductor wire through an extrusion head; supplying a pre-mixed insulation composition to the extrusion head, wherein the pre-mixed insulation composition comprises: polymer base resins, cross-linking catalyst and carbon black; supplying a pre-mixed skin composition to a piggyback skin extruder, wherein the pre-mixed skin composition comprises polymer base resins, cross-linking catalyst colorant and UV protection agent and extruding the insulation composition from the extrusion head and around the conductor wire so as to form insulation surrounding the conductor wire and extruding the skin composition from the piggyback skin extruder.

In some embodiments, wire enters Genca/Milacron D-3079 crosshead that is being fed by a 4.5″ main extruder combined with a 2.5″ piggyback skin extruder. The main extruder insulates the conductor with UV resistant XLPE having carbon black dispersed therein while the piggyback extruder forms a thin coloured skins using a similar XLPE formula having titanium dioxide and colorant.

### Example

A UV jacketed insulated conductor may be formed by the following process:

Wire enters Genca/Milacron D-3079 crosshead that is being fed by a 4.5″ main extruder combined with a 2.5″ piggyback skin extruder. The main extruder insulates the conductor with black sun resistant XLPE while the piggyback extruder forms a thin coloured skins using a similar XLPE formula having the technical properties as follows:

For example to produce #2 AWG Compact Aluminum 600V Black/White Skin Sun Res RW90, #2 AWG compact aluminum wire having a nominal diameter of 0.268″ enters the Genca/Milacron D-3079 crosshead.
RW90 SR Insulation: 4½″ Extruder
Pre-mixed formulation-4 component system (CS-8): 55% DOW 5451 LLDPE-5% DOW 5481 Catalyst-33.5% DOW 5700 HOPE-6.5% DOW 5410 Black Masterbatch
Wall Thickness: 0.045″ minimum average wall, 0.040″ minimum at any point
RW90Skin Coat: 2½ ″ Piggyback Extruder
Pre-mixed formulation-3 component system (CS-1): 55% DOW 5451 LLDPE-4.5% DOW 5481 Catalyst-40.5% DOW 5700 HDPE with 3% of the total mixture being UV Stable PolyOne colour Chips
Wall Thickness: 0.005″ minimum skin coat thickness

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

We claim:

1. An ultraviolet-resistant jacketed insulated conductor comprising:
(a) an inner conductor;
(b) crosslinked insulation having carbon black dispersed therein surrounding the inner conductor; and
(c) an ultraviolet stable colored skin coat.

2. The ultraviolet-resistant jacketed insulated conductor of claim 1, wherein the skin coat comprises titanium dioxide.

3. The ultraviolet-resistant jacketed insulated conductor of claim 2, wherein the carbon black is about 2.5% by weight and the titanium dioxide is between about 0.5% to about 1.2% by weight.

4. The ultraviolet-resistant jacketed insulated conductor of claim 3, wherein the inner conductor is an aluminum conductor or a copper conductor.

5. The ultraviolet-resistant jacketed insulated conductor of claim 4, wherein the insulation comprises crosslinked polyethylene (XLPE) insulation having carbon black dispersed therein and the skin coat comprises XLPE.

6. An ultraviolet-resistant jacketed insulated conductor comprising:
(a) an inner conductor;
(b) crosslinked polyethylene (XLPE) insulation having carbon black dispersed therein surrounding the inner conductor; and
(c) an ultraviolet stable colored skin coat.

7. The ultraviolet-resistant jacketed insulated conductor of claim 6, wherein the skin coat comprises titanium dioxide.

8. The ultraviolet-resistant jacketed insulated conductor of claim 6, wherein the inner conductor is an aluminum conductor or a copper conductor.

9. The ultraviolet-resistant jacketed insulated conductor of claim 6, wherein the XLPE insulation comprises about 2.5% carbon black.

10. The ultraviolet-resistant jacketed insulated conductor of claim 7 wherein the carbon black is about 2.5% by weight and the titanium dioxide is between about 0.5% to about 1.2% by weight.

11. The ultraviolet-resistant jacketed insulated conductor of claim 10, wherein the XLPE insulation has a thickness of at least 0.040″.

12. The ultraviolet-resistant jacketed insulated conductor of claim 11, wherein the XLPE insulation has an average thickness of about 0.045″.

13. The ultraviolet-resistant jacketed insulated conductor of claim 12, wherein the ultraviolet stable skin coat has a thickness of at least 0.005″.

14. The ultraviolet-resistant jacketed insulated conductor of claim 13 wherein the ultraviolet stable skin colored coat is colored with UV stable PolyOne colour chips or Avient® SMARTBATCH® UV stable Munsell color pellets.

15. The ultraviolet-resistant jacketed insulated conducted of claim 14, wherein the ultraviolet stable colored skin coat comprises about 2% to about 3% UV stable PolyOne colour chips or Avient® SMARTBATCH® UV stable Munsell color pellets.

16. A method of making ultraviolet-resistant jacketed insulated conductors comprising:
advancing at least one conductor wire through an extrusion head;
supplying a pre-mixed insulation composition to the extrusion head, wherein the pre-mixed insulation composition comprises: polymer base resins, cross-linking catalyst and carbon black;
supplying a pre-mixed skin composition to a piggyback skin extruder, wherein the pre-mixed skin composition comprises polymer base resins, cross-linking catalyst colorant and UV protection agent and
extruding the insulation composition from the extrusion head and around the conductor wire so as to form insulation surrounding the conductor wire; and
extruding the skin composition from the piggyback skin extruder.
